(19) United States
(12) Patent Application Publication
(10) Pub. No.: US 2011/0244109 A1
(43) Pub. Date: Oct. 6, 2011

(54) Salad dressing

(76) Inventor: Agim Tony Odza, Anna, TX (US)

(21) Appl. No.: 13/065,973

(22) Filed: Apr. 4, 2011

Related U.S. Application Data
(60) Provisional application No. 61/320,707, filed on Apr. 3, 2010.

(51) Int. Cl. A23L 1/24

(52) U.S. Cl. 426/589

(57) ABSTRACT

A method for preparation of salad dressing includes —mixing tomato based chili sauce with red wine vinegar, —stirring them creating a mixture left to rest, stirring and gradually adding salad oil forming a homogenized mixture left to rest —adding sugar and salt —stirring —adding oregano and black pepper —stirring —adding granulated/powder dried garlic and crushed red pepper —stirring for 3 minutes; —adding chopped garlic into and —stirring for 5 minutes thereby, forming the salad dressing, which is the result of unique blend of completely natural and diary-free products, and therefore, a sui generis flavor salad dressing. The required temperature and processing time for each step of the method are provided in the disclosure.

### CROSS-REFERENCES TO RELATED APPLICATIONS

The present patent application claims the benefit of a U.S. provisional patent application Ser. No. 61,320,707 filed on Apr. 3, 2010, the disclosure of which is incorporated herein in its entirety by reference.

### FIELD OF THE INVENTION

The invention at issue aims at a food compound, and a method for preparation of such food compound. Namely, this invention teaches how to make a salad dressing, which is the result of a unique blend of completely natural and diary free products, and therefore, a sui generis flavor salad dressing.

### BACKGROUND OF THE INVENTION

After scientific and technological discoveries in regard to damaging effects of the consumption of certain foods, our society has increasingly become more health conscious, and seeks avoiding illnesses today known to be caused by the everyday ingestion of certain foods. In fact, health scientists have discovered negative effects on the human body of the continuous intake of animal proteins or animal greases, which may contribute, among other problems, to causing the obesity to a large percentage of individuals in the modern society. Besides obesity, an excessive amount of proteins from animal sources causes many other health risks because they are essentially stored in the body as toxins and fats.

Excessive animal protein intake has been linked to mineral loss leading to some forms of cancer, osteoporosis, kidney stones, arthritis, diabetes, cataracts, arteriosclerosis, an irritated immune system, and high cholesterol, which is converted by the liver into fat. Experts recommend that Americans reduce protein intake by about 15 percent and eat less animal proteins and more protein from plant sources.

From the fact that more food stores are offering diary free and healthy products, we realize that there is a demand for the same, and therefore the necessity to create and provide more products that not only can fulfill the demands of the new health conscious society, but also an urge and search for new and improved tastes due to the continuous human insatiable demand for a variety of flavors and new gastronomic adventures.

Furthermore, there is a noticeable trend toward a more vegan society, and such a society is looking for vegan products that can replace in taste and nutritional value the diary products that are now known to be causing health and even moral problems to many consumers.

Salad dressings are commonly known as a daily companion of meals, and therefore there is a continuous intake of the same by the population. For this reason, and the reasons mentioned above, there is a need in the industry for salad dressings that can address and solve the above-mentioned problems. The salad dressing at issue, for this purpose, does not contain harmful ingredients for the human body, and for the particular blending process necessary for the making of the same, which gives to the salad dressing a strong flavor, allows consumers to be satisfied with a small amount of it, and to find with it a further new and unique taste.

### PURPOSE AND SUMMARY OF THE INVENTION

The present invention provides a food compound, namely a salad dressing, which solves the problems that common salad dressings can typically cause. This salad dressing is made completely without animal proteins, which have been found the cause of cholesterol, and consequently hearth attach, and other health problems like mineral loss leading to some forms of cancer, osteoporosis, kidney stones, arthritis, diabetes, cataracts, arteriosclerosis, and obesity. It also solve the problem of fulfilling the urge of improved and new savors by being composed by a unique blend of completely natural and healthy ingredients, and providing, therefore, a very unique and new flavor.

Furthermore, it avoids the intake of an excessive amount of the same, and for this reason, it avoids all the problems connected with the intake of excessive amounts of food. This is due to the fact that the dressing at issue has a very strong flavor, and a particular consistency given by the particular blending method used for the making of it that allows the food on which it is used to acquire the full flavor of the dressing with a small amount of the same. It also provides an alternative to tomato based salad dressings that are usually composed of diary products, and an alternative tomato based dressing to the increasingly larger vegan community urging new flavors.

It is well known that many salad dressings have been produced, and are at present on the low-carbohydrate, low-fat, low-cholesterol, diary-free market. Nevertheless it seems yet not possible to find products that are of such a category, and that, at the same time, are able to satisfy the market continuous demand for better and new tastes, and that do not require a large quantity of the dressing for it to be tasty. This is a common fact that unfortunately causes the problems above described, and that our dressing solves. In fact, the particular formula of our food compound, combined with a particular blending method, which involves a particular, unique sequence of interaction among the ingredients of the final compound, as a result, provides a very intense flavor of the latter with use of a small amount thereof.

Furthermore, the blending of the ingredients to obtain the food compound at issue is measured and thought to create a balance of the ingredients that allows a cup of oil always to be naturally formed on the top of the containers of the dressing that provides a natural seal to the other ingredients of the dressing, and a preservation of the same.

The uniqueness and novelty of the invention is given not only by the unique combination of the ingredients, but also by the unique method of preparation. Thusly, the ingredients and method for preparation thereof in combination provide a unique and new final result unobvious for a person skilled in the art.

### BRIEF DESCRIPTION OF DRAWINGS

FIG. 1 shows a flowchart indicating a first portion of steps necessary for accomplishing the inventive method for preparation of the inventive dressing.

FIG. 2 shows a flowchart indicating a second portion of steps necessary for accomplishing the inventive method for preparation of the inventive dressing.

### PREFERRED EMBODIMENT OF THE INVENTION

While the invention may be susceptible to embodiment in different forms, there will be described in detail herein a specific exemplary embodiment of the present invention, with the understanding that the present disclosure is to be considered an exemplification of the principles of the invention, and is not intended to limit the invention to that as illustrated and described herein.

The sequence of mixing certain ingredients, after being stored at predetermined temperatures, and the inventive method of stirring and mixing the ingredients generate interactions between the ingredients that, as a result, creates a new food compound, with a unique taste. Although made primarily to be used to coat salads, the inventive dressing can also be used as a healthy, diary free dressing for any other food.

The present invention contemplates a composition of food ingredients and a method for preparation thereof Therefore, the invention provides a salad dressing, which is the result of a unique blend of completely natural and diary free products, and therefore, a sui generis flavor salad dressing.

The invention provides for preparing a unique tomato based salad dressing, which involves the use of the following ingredients in the following proportion:

Preferable Types of Ingredients %:
Chili Sauce Canned/Bottled Tomato, Corn Syrup, Vinegar+—40.09;
Red Wine Vinegar Canned/Bottled Liquid—20.01;
Salad Oil Canned/Bottled 99% Soya Oil, 1% Olive Oil—33.36;
Chopped Garlic Canned/Bottled in Water—3.71;
Sugar Dried/Dehydrated Iodized Table Salt—1.10;
Salt Dried/Dehydrated Granulated 1.30;
Granulated Garlic Dried/Dehydrated Granulated—0.23;
Black Pepper Dried/Dehydrated Ground—1.11
Oregano Dried/Dehydrated Dry Leaves—0.17;
Crushed Red Pepper Dried/Dehydrated Dried—0.001.

The following method should preferably be used to create the inventive salad dressing, once all the above ingredients have been prepared in the amounts deemed appropriate in relation to the final quantity to be reached. A blending machine with speed options can be used to produce the inventive salad dressing.

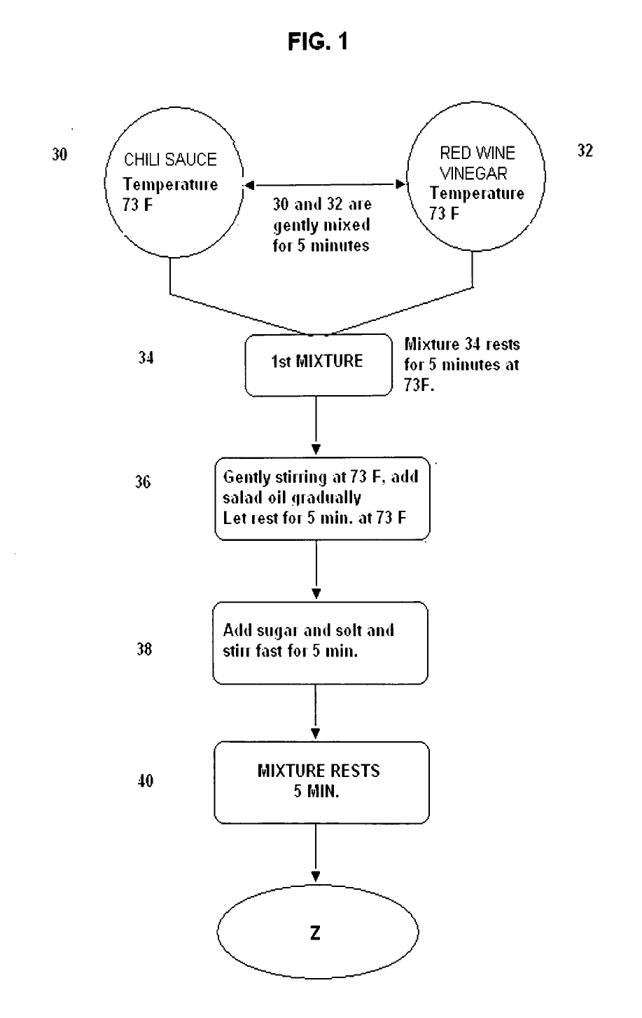

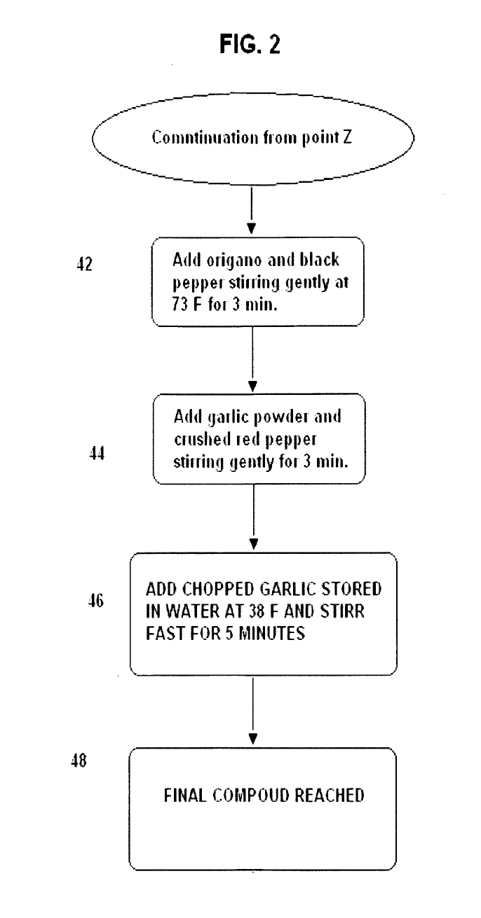

Referring to the attached drawings (FIG. 1, and FIG. 2) the following reference numerals denote the following ingredients: as reported in FIG. 1, the selected tomato based Chili Sauce 30, stored at a temperature of about 73 F.° degrees, is mixed gently, at first, with red wine vinegar 32 stored at a temperature also of about 73 F.° degrees. These two ingredients must be stirred properly for 5 minutes to create a homogenized compound—mixture 34.

The thus obtained mixture 34 has to be left resting for 5 minutes at a temperature of about 73 F.° degrees for the ingredients 30 and 32 to interact properly and to generate the basis for the further mixture. Gently stirring at a temperature of about 73 F.° degrees, salad oil is gradually added until the new compound is formed in a homogenized mixture 36.

The so formed mixture 36 needs to be kept at a temperature of 73 F.° degrees and needs to settle for 5 minutes.

Sugar and salt are added simultaneously into the mixture 36, thereby obtaining a mixture 38, and a fast stirring has to take place this time, for about 5 minutes, for blending purposes and to have sugar and salt completely dissolved in the mixture 38 thereby forming a mixture (compound) 40.

Once the mixture 40 is reached it is essential to provide an interaction of all the above named ingredients at a temperature of 73 F.° degree for about 5 minutes.

The mixture 40, at this point, is ready to go through the further two mixing stages 42 and 44, (illustrated on FIG. 2), namely, adding oregano and black pepper first, stirring the mixture gently at a temperature of about 73 F.° degree for 3 minutes, and then adding the granulated/powder dried garlic and the crushed red pepper at the same temperature and stirring for the same duration of time (3 minutes).

The final stage of the blending process is comprised of an addition of the chopped garlic of the type stored in water. The chopped garlic, stored in water at a temperature of 38 F.° degrees, must be added to the mixture reached at a point 44.

The mixture obtained must undergo a final fast stirring process 46 to allow the substances that are released by garlic to interact intensely with the compound, and provide a final salad dressing 48 with a unique taste that otherwise could not be reached.

It is absolutely important to follow the steps above described to obtain the best mode of the inventive salad dressing. Different stirring length or modalities, temperatures of storage of the ingredients, will not generate the desirable taste of inventive salad dressing.

What is claimed is:

1. A method for preparation of salad dressing comprising the steps of:
providing tomato based chili sauce (30), stored at a temperature substantially of 73 F.° degrees;
providing red wine vinegar (32) stored at a temperature substantially of 73 F.° degrees;
gently mixing and stirring said sauce (30) with said vinegar (32) substantially for 5 minutes thereby creating a mixture (34);
leaving said mixture (34) to rest substantially for 5 minutes at a temperature substantially of 73 F.° degrees;
gently stirring said mixture (34) gradually adding salad oil thereby forming a homogenized mixture (36);
leaving said mixture (36) to rest substantially for 5 minutes at a temperature substantially of 73 F.° degrees;
simultaneously adding sugar and salt into said mixture (36) thereby obtaining a mixture (38);
predeterminedly quickly stirring said mixture (38) substantially for 5 minutes thereby forming a mixture (40);
leaving said mixture (40) to rest substantially for 5 minutes at a temperature substantially of 73 F.° degrees;
adding oregano and black pepper into said mixture (40) thereby obtaining a mixture (42);
stirring said mixture (42) gently at a temperature substantially of 73 F.° degree substantially for 3 minutes;
adding granulated/powder dried garlic and crushed red pepper into said mixture (42) at a temperature substantially of 73 F.° degree thereby obtaining a mixture (44);
stirring said mixture (44) at a temperature substantially of 73 F.° degree substantially for 3 minutes;
providing chopped garlic, stored in water at a temperature substantially of 38 F.° degrees;
adding said chopped garlic into said mixture (44) thereby obtaining a mixture (46); and
predeterminedly quickly stirring said mixture (46) substantially for 5 minutes thereby forming said salad dressing (48).
